(19) United States
(12) Patent Application Publication
(10) Pub. No.: US 2023/0071646 A1
(43) Pub. Date: Mar. 9, 2023

(54) METHOD OF ADDITIVE FORMING OF A 3D OBJECT BY LAYERING BASIC BLOCKS

(71) Applicant: Michal JANCOSEK, Tomasov (SK)

(72) Inventor: Michal JANCOSEK, Tomasov (SK)

(21) Appl. No.: 17/799,109

(22) PCT Filed: Nov. 9, 2020
(86) PCT No.: PCT/SK2020/050019

§ 371 Date: Aug. 11, 2022

(51) Int. Cl. B29C 64/141; B29C 64/40; E04B 2/20

(52) U.S. Cl. CPC B29C 64/141; B29C 64/40; E04B 2/20; B33Y 70/00

(57) ABSTRACT

A method of additive forming of a 3D object by layering solid base blocks (3) comprises the following steps:
a. arranging at least one guiding element (2) oriented in the direction of forming of the 3D object;
b. depositing a first layer comprising at least one solid base block (3) in the horizon of the first layer;
c. depositing at least one further layer comprising at least one solid base block (3) at a horizon spatially spaced from the horizon of the first layer in the direction of forming the 3D object;
   while at least one base block (3) of the at least one layer is arranged in the region of the at least one guiding element (2) and is arranged with at least one cooperating means (4), cooperating with the said at least one guiding element (2).

3D object can also contain various solid base blocks (3). It is advantageous if the first layer is arranged on the base plate (1). It is advantageous if at least one base block (3) is arranged with a fastening means (5), for example an adhesive. It is advantageous if, after step c), the base plate (1) and/or the at least one guiding elements (2) are removed. The 3D object can be strengthened by a thermal process.

### FIELD OF THE INVENTION

The invention relates to a method of additive forming of a 3D object by layering basic blocks. The invention belongs to the field of additive manufacturing of 3D objects.

### BACKGROUND OF THE INVENTION

At present, an additive technology for the manufacturing of spatial objects using 3D printers is known, which are based on the same basic principle, i.e. they create an object using digital design data by curing the fusible material gradually in one layer after another. Additive technology for the manufacturing of spatial objects on 3D printers produces objects of various sizes, shapes and structures. There are several methods of 3D printing. Each of the methods differs in price, speed, accuracy and materials used, has its advantages and disadvantages. In melt deposition modeling technology, the plastic fiber is fed to a printer, where it is melted and applied in layers that gradually solidify. A characteristic document describing this technology is WO 2018/223043 A1, where in addition support beams are also used. In selective laser sintering technology, a fine powder (metal or plastic) is applied and a laser moves over it, which selectively bakes it into the bottom layer. This allows a wide variety of materials to be used. A characteristic document describing this technology is also the document JP 2019/147343 A, where, in addition, supporting objects are also used. In stereolithography technology, a photosensitive liquid resin is illuminated by a laser or UV light that will cure it. This process is fast and can create shapes with very high resolution. However, the result are objects with limited material strength.

Methods for additive forming of 3D objects by depositing solid blocks are also known in the prior art, as described in CN 109049687 A, where solid base blocks of various shapes are first formed from thermoplastic resin material reinforced with fibers, and then these blocks are deposited in layers, the surface of the blocks is coated with adhesive. Blocks in the same layer can have different heights. Document EP 3427869 A1 is also known, where a method of manufacturing 3D objects based on joining prefabricated blocks into layers is described. The solid material from which the blocks are prepared is selected from the group of metallic, polymeric, composite material and combinations thereof.

None of the technologies described above, in particular the technology of laying blocks in layers, contains an additional structure which would guarantee the accuracy of the laying of blocks, the strength of the joined blocks and the possibility of easy creation of various overhangs and openings.

### SUMMARY OF THE INVENTION

The above-mentioned drawbacks of the prior art are eliminated by the method of additive forming of a 3D object by layering the basic blocks according to the invention. The solution is based on placing blocks of any shape on guiding elements, preferably realized by a rod or a thin cable, while they are preferably placed on top of each other. The guiding elements are preferably embedded or anchored on the base plates parallel to each other, for example in a grid, thus filling the working space. The number and arrangement of the used guiding elements is preferably determined according to the desired characteristics of the object being formed, taking into account the materials used.

The basis of the method of additive forming of a 3D object by layering solid base blocks lies in the following steps. At first is formed an arrangement of at least one guiding element oriented in the direction of forming of the 3D object. This is followed by depositing a first layer comprising at least one solid base block in the horizon of the first layer and depositing at least one further layer comprising at least one solid base block in a horizon spatially distant from the horizon of the first layer in the direction of forming of a 3D object. For the purposes of the present invention, the term “horizon” is intended to mean an imaginary two-dimensional geometric shape in space passing through the geometric center of each base block of a given layer.

In this case, the at least one base block of the at least one layer is arranged in the region of the at least one guiding element and is arranged with at least one cooperating means, cooperating with the said at least one guiding element. Preferably, at least one such base block is arranged in each layer, in which case the overall strength as well as the dimensional accuracy of the finally formed object is increased. Advantageously, it is possible to use, for example, holes in the volume of the base block or mechanical means known to those skilled in the art as cooperating means. It is also possible for at least one solid base block of each layer to be arranged in the region of at least two guiding elements and to be arranged with at least two cooperating means, each of which cooperates with at least one of these guiding elements. It is also possible for at least one solid base block of each layer to be arranged in the region of the at least two guiding elements and to be arranged with at least one cooperating means which cooperates with these at least two guiding elements.

At least two different base blocks can advantageously be used in the method according to the invention. In this case, the final object may advantageously be composed of different materials. Thanks to this, it is possible to create pre-designed objects with different qualitative and aesthetic properties of their individual parts.

It follows from the method that the first layer is preferably arranged on at least one base plate and the horizon of the at least one further layer is preferably parallel to the horizon of the first layer. If the horizon of at least one and preferably all subsequent layers is parallel to the horizon of the first layer, the whole forming method is considerably simplified and accelerated, independently of the possible use of the base plates. It is characteristic of this method that the at least one guiding element is oriented in a direction perpendicular to the horizon of the first layer or that it is also possible for the at least one guiding element has been oriented in a direction other than perpendicular to the horizon of the first layer, e.g. parallel or slantigly. By using guiding elements oriented perpendicular to the horizon of the first layer, the forming process is greatly simplified and accelerated. By the perpendicular direction of the orientation of the guiding element we mean that the angle between the longitudinal axis of the guiding element and the horizon of a given layer at their intersection is perpendicular. Other angles given in connection with the arrangement of the guiding elements in relation to the horizon of a given layer must be understood analogously. It is preferred that the at least one base block will be arranged with the fastening means or that all solid base blocks will be arranged with the fastening means. Preferably, the fastening means is an adhesive or other suitable fastening material. It is also possible to use mechanical fastening means, such as screws and nuts. It is possible for the fastening means to be a contact surface from thermoplastic material from which the base block is made or with which the base block is at least partially coated. Strengthening occurs after the thermal process. For some uses of a 3D object it is advantageous that after step c), the base plate, if used, will be removed and/or at least one guiding element will be removed. In order to strengthen the 3D object the 3D object is preferably reinforced by a thermal process. In this case, it is advantageous if at least one base block is made of a thermoplastic material.

The advantages of the method of additive forming of a 3D object by layering basic blocks are in that the proposed solution can advantageously store zigzag blocks, for example if at least one base block is arranged in the area of at least two guiding elements and is arranged with at least one alignment means cooperating with at least two guiding elements, preferably without the need for the use of a fastening means. The guiding means also enable a more precise placement of the individual basic blocks and thus a greater shape accuracy of the formed 3D object.

If a fastening means is used, the base blocks arranged with the fastening means can be advantageously pressed together at different levels by means of guiding elements for a longer period of time in order to achieve a good connection. In this case, it is advantageous if at least one base plate is used. The guiding elements and the base plate serve primarily as a structure guaranteeing the accuracy of the production and also serve as a support structure for creating pressure for the use of the fastening means. Upon completion of the iterative process of depositing and hardening the blocks, at least one guiding element and/or at least one base plate can advantageously be removed and the resulting object will be solid and can have any spatial shape.

By a suitable combination of the use of fastening means, guiding means and preferably also of the base plate or plates, it is possible to create self-supporting structures of objects in a very flexible way without other supporting structures.

Another significant advantage of the solution is the creation of various overhangs and openings so that the stored support blocks will not be e.g. arranged without a fastening means and after completion of the additive forming of the 3D object by layering, they are removed and optionally can be recycled during further forming of the 3D object. When forming higher 3D objects, overhangs and sloping surfaces on the built higher layers can be made using guiding elements oriented in a direction other than perpendicular to the horizon of the first layer, thus saving a number of basic blocks, which would serve only as supporting elements during construction and at the end will be removed. This method of additive forming of a 3D object by layering allows the use of blocks of different materials, e.g. thermoplastic materials, colors and dimensions, thus having a wide application. Also, the size of blocks and grids allows to produce devices for additive forming of 3D objects of various sizes, whether for the manufacturing of small 3D objects such as vases, cups, flower pots, etc., or medium-sized objects such as cabinets, chairs and furniture in general. It is also possible to manufacture human and animal figures in real size. Finally, it is possible to manufacture whole houses.

### OVERVIEW OF DRAWINGS

The method of additive forming of a 3D object by layering the basic blocks according to the invention is illustrated in the accompanying drawings, in which:

FIG. 1 shows the types of elements of the layered 3D object itself, also with the guiding element and the base plate of the device, which are necessary for carrying out the additive forming method and also with the alignment means of the device.

FIG. 2 shows the placement of the blocks of the first layer of the 3D object on the base plate also with the embedded guiding elements.

FIG. 3 shows the application of pressure to the first layer of stored blocks of a 3D object in order to achieve the accuracy of the arrangement.

FIG. 4 shows the application of pressure for a sufficient time to the last layer of the stored blocks of the 3D object in order to achieve the accuracy of the arrangement and at the same time in order to thoroughly apply the fastening means and fasten the blocks.

FIG. 5 shows the removal of some loose blocks and the guiding structure.

FIG. 6 shows the final formed 3D object after removing the base plates, guiding elements and remaining unattached blocks.

FIG. 7 shows the final terrace 3D object with the arranged guiding elements and base plates after the removal of the alignment means and some unattached blocks.

FIG. 8 shows the final terrace 3D object created after removal of the alignment means, guiding elements and base plates and all unattached blocks.

FIG. 9 shows the placement of a block of the last layer of a 3D object on an embedded guiding element.

FIG. 10 shows the placement of blocks of a 3D object with a horizontally oriented niche.

FIG. 11 shows the placement of blocks of a 3D object with a sloping roof.

FIGS. 12, 13 and 14 show the arrangement of a 3D object in the shape of an expanding trihedron in bottom, side and top views.

All figures show preferred embodiments with fastening means used on the base blocks, shown by a double contour line.

### EXAMPLES OF EMBODIMENTS OF THE INVENTION

It is to be understood that the individual embodiments of the invention are presented by way of illustration and not by way of limitation. Those skilled in the art will find, or be able to ascertain using no more than routine experimentation of many equivalents to specific embodiments. Such equivalents will also fall within the scope of the claims. Optimal method design cannot be a problem for those skilled in the art, so these features have not been described in detail.

FIG. 1 shows a range of elements that are necessary for the additive forming of a 3D object by layering base blocks. The range of elements thus consists of base plates 1, of guiding elements 2, which are rods, sticks or cables, wires, various rod profiles and the like. Furthermore, they are the basic blocks 3 in the shape of a block and a cube with one cooperating means 4—a hole, an opening for the guiding elements 2. They are also the basic blocks 3 in the shape of a block and a cube with two cooperating means 4—holes, openings for guiding elements 2. They are also the base blocks 3 themselves with the fastening means 5 applied—e.g. glue with one cooperating means 4—hole, opening for guiding elements 2. They are also the base blocks 3 themselves with the fastening means 5 applied—e.g. glue with two cooperating means 4—holes, openings for guiding elements 2. The basic blocks can generally be blocks of any shape and material. The device that will perform the additive forming of a 3D object by layering the basic blocks is not subject to protection, nor is it shown in any image. The reference is to only one member of this device, namely the alignment means 6, cooperating with one auxiliary element of the technology, which is the guiding element 2. The alignment means 6 is e.g. robotic arm or sliding cat, or special bar.

### Example 1

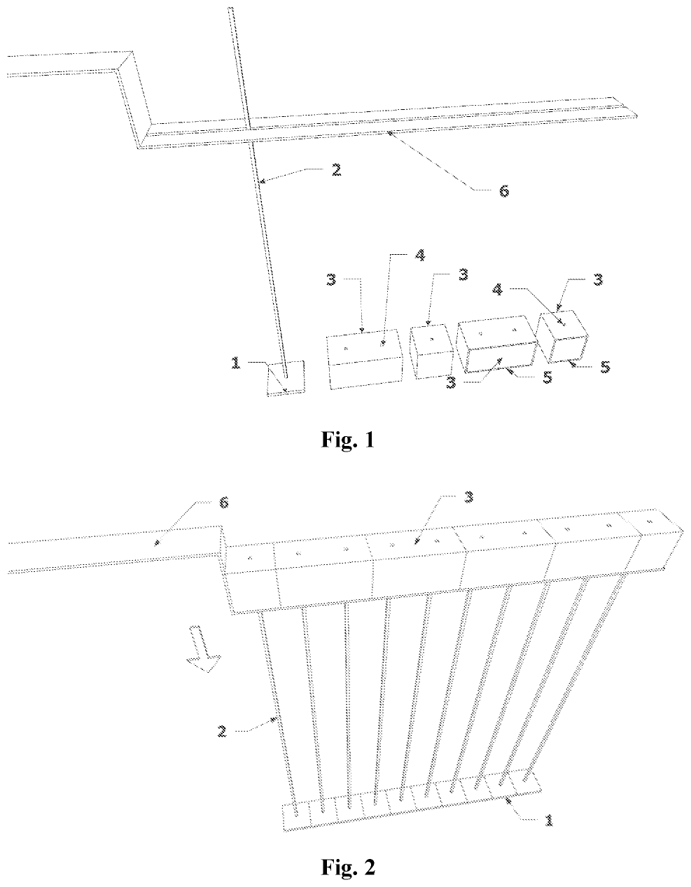

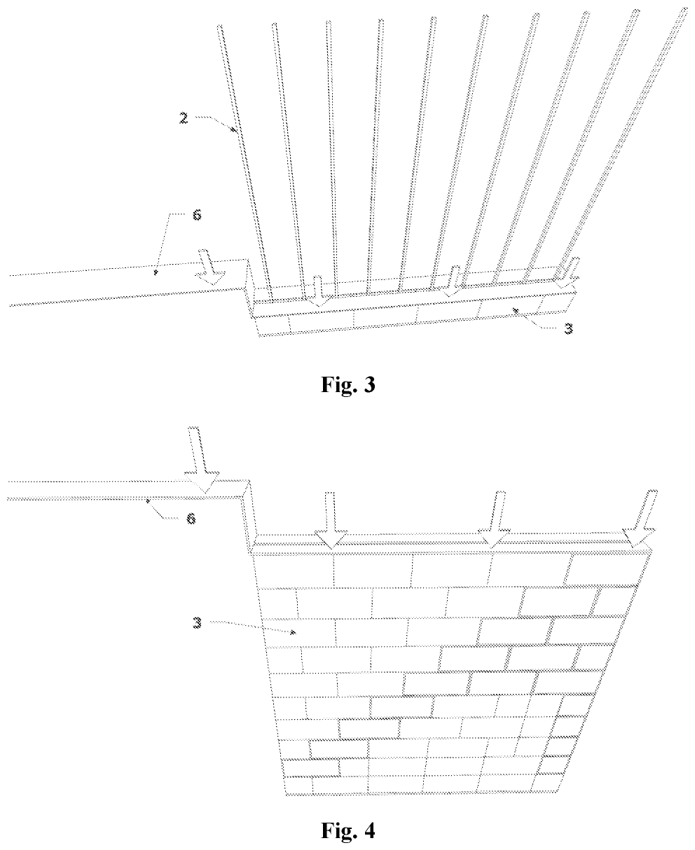

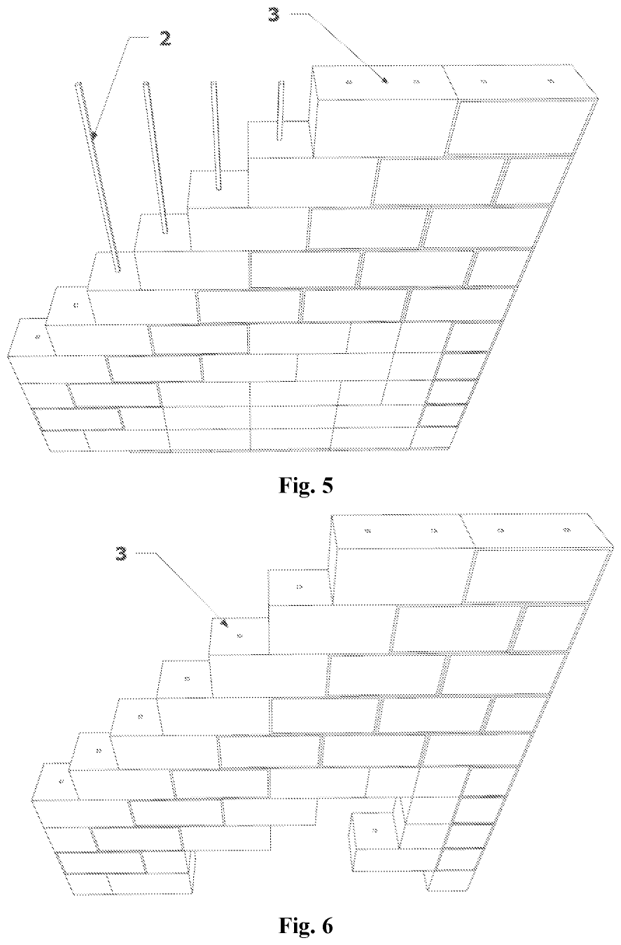

In this example of a specific embodiment an implementation of the method of additive forming of a 3D object by layering base blocks according to the invention is described, which is illustrated on created a 3D object—stairs with an opening in the base and central part shown in FIGS. 1 to 6. The method of additive forming of a 3D object by layering solid base blocks 3 consists of the following steps: Initially, the required number of guiding elements 2 is prepared and distributed. The number of guiding elements is determined according to the required characteristics of the object being formed, taking into account the materials used. This creates a linear working grid with parallel guiding elements 2 axially oriented in a direction perpendicular to the horizon of the first layer, the guiding elements being oriented in the direction of forming the 3D object. This operation is preferably preceded by an auxiliary operation taking place outside the space of additive forming of the 3D object, which is the deposition of the first layer of base blocks 3 on the alignment means 6. Preferably, an auxiliary operation follows, which is the movement of the base blocks 3 of the first layer on the alignment means 6 exactly above the guiding elements 2 arranged in one line in the horizon of the first layer, while the cooperating means 4 on the base blocks 3 being above the guiding elements 2. The next step is to deposit the first layer of solid base blocks 3 in the horizon of the first layer by means of cooperating means 4, through which they are threaded on the guiding elements 2 by means of the alignment means 6 of the processing device. Alternatively, two or more non-illustrated alignment means 6 may be used. The horizons of all subsequent layers are parallel to the horizon of the first layer. The placement of the base blocks 3 of the first layer on the guiding elements 2 takes place by a vertical displacement of the base blocks 3 of the first layer placed on the alignment means 6, what is shown in FIG. 2. Another advantageous auxiliary action is to extend the alignment means 6 from below the first layer out of the additive forming space of the 3D object and to slide it over the already stored first layer of base blocks 3, the alignment means 6 exerting pressure on the first layer of base blocks 3 to achieve arrangement accuracy, what is shown in FIG. 3. The horizon of the next layer is spatially distant from the horizon of the previous layer in the direction of forming the 3D object by the height of the solid base blocks 3. This is followed by the step of depositing the second layer of base blocks 3 at a horizon spatially spaced from the horizon of the first layer in the direction of forming the 3D object, this layer and subsequent layers already containing respective base blocks 3 provided preferably with fastening means 5—e.g. glue. This is done until the last layer of the base blocks 3 is deposited and pressure is applied for a sufficient time in order to achieve the accuracy of the arrangement and at the same time in order to solidify the adhesive and stick the base blocks 3, as shown in FIG. 4. In the next step, the removal of all the guiding elements 2 and some of the non-glued base blocks 3 takes place, as shown in FIG. 5.

In a preferred alternative, the preparation and layout of the base plates 1 are initially arranged and arranged in such a way that an imaginary two-dimensional geometric shape in space passing through the geometric center of each base layer is in principle parallel to the horizon of the first layer, while in the centre of each base plate 1 one guiding element 2 is arranged as shown in FIG. 1. The number of base plates 1 is determined according to the required characteristics of the formed object, taking into account the materials used. Then, the first layer of base blocks is deposited as described above.

Finally, the remaining unreinforced, non-glued base blocks 3 and all the base plates 1 are removed, thus creating an opening in the base and central part of the 3D object as shown in FIG. 6.

This method of additive forming of a 3D object by layering the basic blocks according to the invention is optionally supplemented by a strengthening thermal process for strengthening the formed 3D object. In such a case, it is preferable that at least a part of the used base blocks comprise the thermoplastic material.

### Example 2

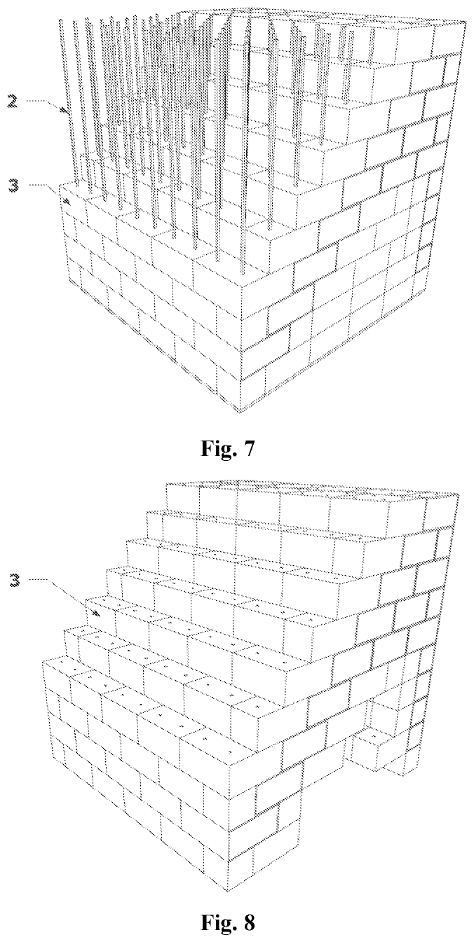

In this example of a specific embodiment an implementation of the method of additive forming of a 3D object by layering base blocks according to the invention is described, which is illustrated on a 3D object—terrace structure with an opening in the base and central part shown in FIGS. 7 and 8. The method of additive forming of a 3D object by layering solid base blocks 3 consists of the following steps: Initially, the preparation and layout of the base plates 1 in this case preferably takes place arranged in such a way that an imaginary two-dimensional geometric shape in space passing through the geometric center of each base layer is in principle parallel to the horizon of the first layer. A planar working grid is formed when one guiding element 2 is arranged in the center of each grid—the base plate 1, oriented in a direction perpendicular to the horizon of the first layer, thus being oriented in the direction of forming a 3D object. Analogously, it is possible to create this planar working grid without disassembling the base plates 1, for example as described in Example 1. The next step is to deposit the first layer of solid base blocks 3 on base plates 1 by means of cooperating means 4, through which they are threaded on the guiding elements 2 by means of the alignment means 6 of the production device. Then it follows with the further steps already described in Example 1.

### Example 3

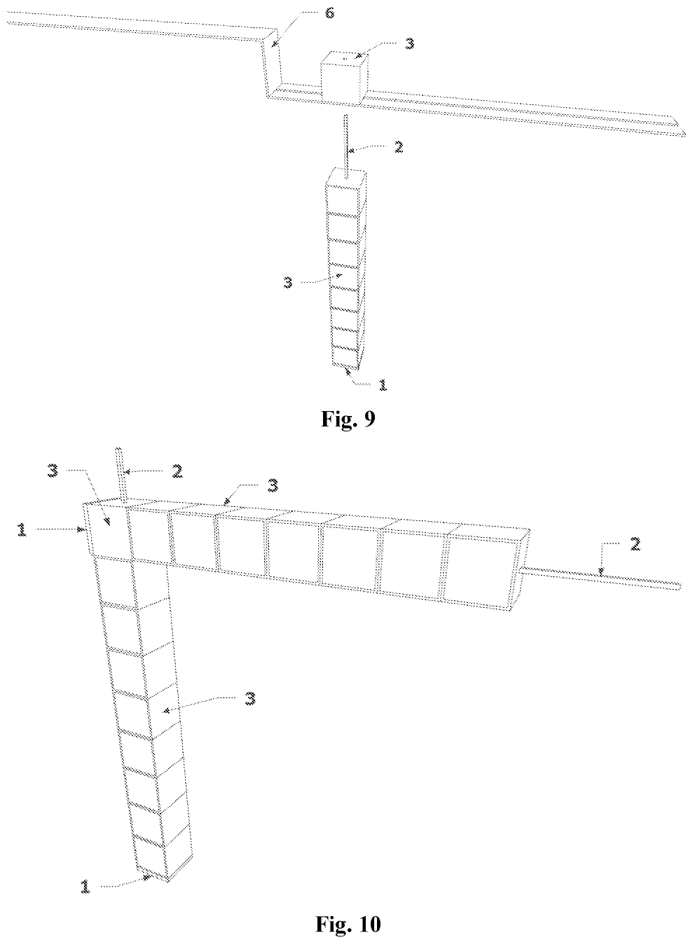

In this example of a specific embodiment an implementation of the method of additive forming of a 3D object by layering base blocks according to the invention is described, which is illustrated on created a 3D object—column and shown in FIG. 9. The method of additive forming of a 3D object by layering solid base blocks 3 consists of the following steps: At the beginning, the preparation and disassembly of one base plate 1 preferably takes place, where one guiding element 2 oriented in the direction of forming a 3D object is arranged in its center. Alternatively, it is possible to proceed without disassembling the base plate 1, analogously to the one described in Example 1. The next step consists in depositing the first layer of one solid base block 3 on the base plate 1 by means of a cooperating means 4, through which it is threaded on the guiding element 2 by means of the alignment means 6 of the production device. Then it follows with the further steps already described in Example 1.

### Example 4

In this example of a specific embodiment an implementation of the method of additive forming of a 3D object by layering base blocks according to the invention is described, which is illustrated on created 3D object—high wall with a niche shown in FIG. 10 and which is basically described in Example 1. In addition, a horizontal niche is formed so that on the last layer of the wall, the guiding elements 2 for building the niche are oriented in a direction other than perpendicular to the horizon of the first layer of the built wall.

### Example 5

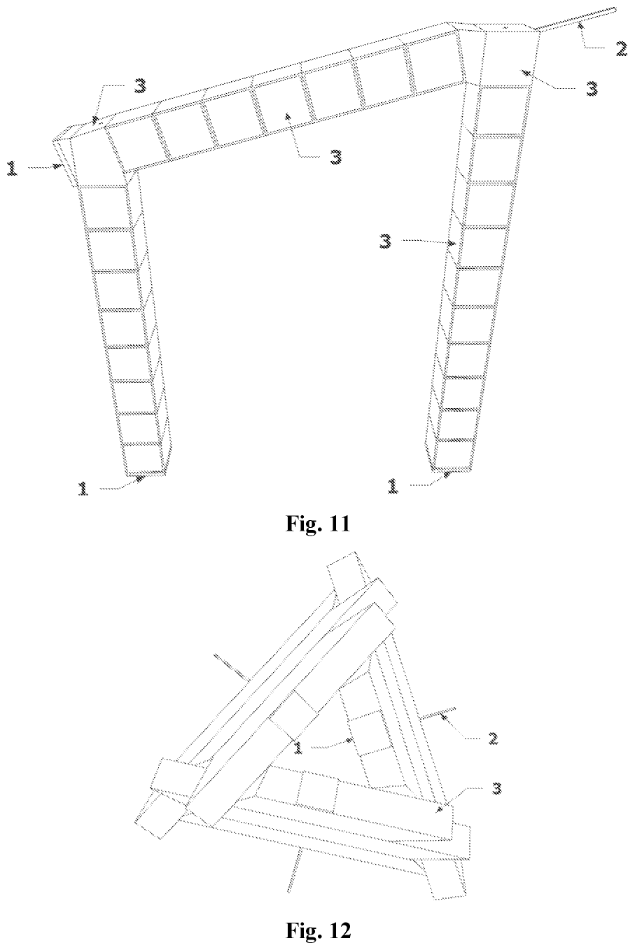

In this example of a specific embodiment an implementation of the method of additive forming of a 3D object by layering base blocks according to the invention is described, which is illustrated on created 3D object—farm building with a sloping roof shown in FIG. 11 and which is basically described in Example 1. In addition, a sloping roof is formed in such a way that on the last layer of walls the guiding elements 2 for building the roof are oriented in a direction other than perpendicular to the horizon of the first layer of built walls.

### Example 6

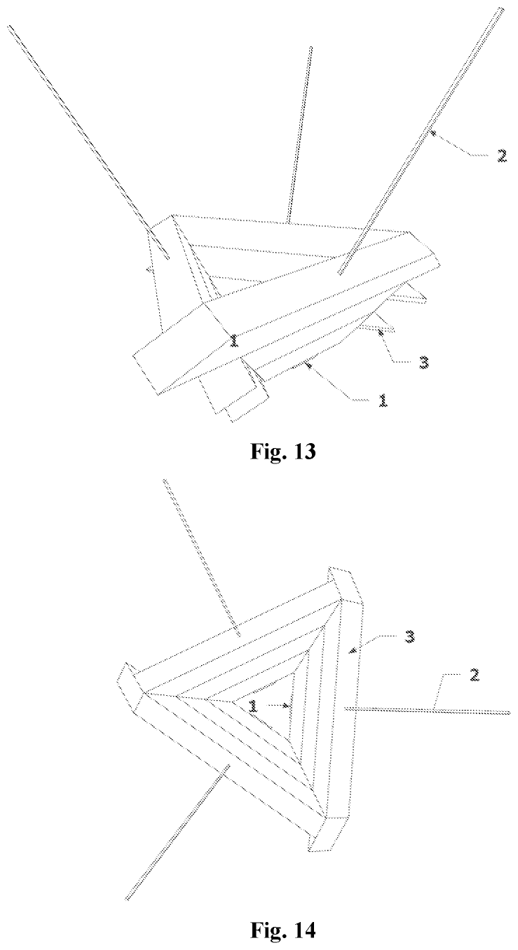

In this example of a specific embodiment, an embodiment of the method of additive forming of a 3D object by layering base blocks according to the invention is described, what is illustrated on created the 3D object—the shape of a diverging trihedron in the bottom, side and top views shown in FIGS. 12, 13 and 14. Initially, the three base plates 1 are prepared and distributed into a triangle configuration as shown in FIG. 12. The guiding element 2 is adapted to each base plate in such a way that they are not arranged in parallel but their vertices run outwards from the object as shown in FIG. 13. In FIG. 14 is shown a constructed 3D object from monolithic base blocks 3.

### Industrial Usability

The method of additive forming of a 3D object by layering solid base blocks according to the invention is usable in the construction industry, the furniture industry, in the production of toys and small utility objects.

1. A method of additive forming of a 3D object by layering solid base blocks comprising the following steps:
a. arranging at least one guiding element oriented in a direction of forming of the 3D object;
b. depositing a first layer comprising at least one solid base block in a horizon of the first layer;
c. depositing at least one further layer comprising at least one solid base block at a horizon spatially spaced from the horizon of the first layer in the direction of forming the 3D object;
while at least one base block of the at least one layer is arranged in the region of the at least one guiding element and is arranged with at least one cooperating means, cooperating with the said at least one guiding element and the at least one base block is arranged with a fastening means;
d. removing the at least one guiding element.

2. The method according to claim 1, wherein at least one base block of each layer is arranged in the region of the at least one guiding element and is arranged with at least one cooperating means, cooperating with the said at least one guiding element.

3. The method according to claim 1, wherein the at least one solid base block of the at least one layer is arranged in the region of the at least two guiding elements and is arranged with at least two cooperating means, of which each cooperates with at least one of these guiding elements.

4. The method according to claim 1 the at least one solid base block of the at least one layer is arranged in the region of the at least two guiding elements and is arranged with at least one cooperating means cooperating with these at least two guiding elements.

5. The method according to claim 1, wherein the at least two solid base blocks are different.

6. The method according to claim 1, wherein the first layer is arranged on at least one base plate.

7. The method according to claim 1, wherein the horizon of the at least one further layer is parallel to the horizon of the first layer.

8. The method according to claim 1, wherein the at least one guiding element is oriented in a direction perpendicular to the horizon of the first layer.

9. The method according to claim 1, wherein the at least one guiding element is oriented in a direction other than perpendicular to the horizon of the first layer.

10. The method according to claim 1, wherein all solid base blocks are arranged with fastening means.

11. The method according to claim 1, wherein the fastening means is an adhesive.

12. The method according to claim 1, wherein after step c) the base plate is removed.

13. The method according to claim 1, wherein the 3D object is reinforced by a thermal process.

14. The method according to claim 1, wherein the base blocks with the at least one cooperating means are arranged in the region of the at least one guiding element by means of the at least one alignment means.

15. The method according to claim 1, wherein after step (c) but before step (d) the at least one base block, arranged with a fastening means, is pressed together with at least one other base block by means of at least one guiding element.

16. The method according to claim 1, wherein after completion of the additive forming of the 3D object, at least one base block is removed.

17. (canceled)
